(19) United States
(12) Patent Application Publication
(10) Pub. No.: US 2024/0223389 A1
(43) Pub. Date: Jul. 4, 2024

(54) Computer-Implemented Method for Providing Cryptographic Keys for Signing Data, Signature Module, Method for Signing Data, and Method for Authenticated Communication

(71) Applicant: Siemens Aktiengesellschaft, München (DE)

(72) Inventors: Hans Aschauer, München (DE); Fabrizio De Santis, München (DE); Rainer Falk, Erding (DE); Andreas Furch, Freising (DE); Daniel Schneider, München (DE); Thomas Zeschg, München (DE)

(73) Assignee: Siemens Aktiengesellschaft, München (DE)

(21) Appl. No.: 18/558,071

(22) PCT Filed: Apr. 26, 2022
(86) PCT No.: PCT/EP2022/061012

§ 371 Date: Oct. 30, 2023

(30) Foreign Application Priority Data
Apr. 30, 2021 (DE) 10 2021 204 340.2

(51) Int. Cl. H04L 9/00; H04L 9/08; H04L 9/32

(52) U.S. Cl. CPC H04L 9/50; H04L 9/0825; H04L 9/3236; H04L 9/3247

(57) ABSTRACT

Various teachings of the present disclosure include methods for providing cryptographic keys for signing data. The method may include: providing a plurality of keys as leaves of a hash tree structure having at least one first hash tree; evaluating a requirement criterion for a requirement for additional keys and, if the requirement criterion is satisfied, generating a plurality of additional keys available as leaves of a further hash tree; and integrating the further hash tree into the hash tree structure so a respective root of the further hash tree is signed with a leaf of the hash tree structure. A number of hash trees of the hash tree structure is not predetermined.

### CROSS-REFERENCE TO RELATED APPLICATIONS

This application is a U.S. National Stage Application of International Application No. PCT/EP2022/061012 filed Apr. 26, 2022, which designates the United States of America, and claims priority to DE Application No. 10 2021 204 340.2 filed Apr. 30, 2021, the contents of which are hereby incorporated by reference in their entirety.

### TECHNICAL FIELD

The present disclosure relates to electronic communication. Various embodiments include methods for providing cryptographic keys for signing data, signature modules, methods for signing data, and/or methods for authenticated communication.

### BACKGROUND

The security of current asymmetric cryptographic methods, in particular signature methods, is regularly based on the difficulty of solving a specific type of mathematical problems. In particular, that involves trapdoor functions, defined as functions which can be calculated easily in one direction, but with difficulty in the other direction if specific additional information is not available. Such mathematical problems are for instance the factorization problem or the discrete logarithm problem or the elliptic curve discrete logarithm problem. These methods will be vulnerable to attack by powerful quantum computers in the future.

Therefore, new cryptographic methods are currently being developed which—from today's perspective—are secure against attacks by future quantum computers. Such cryptographic methods are also referred to as post-quantum cryptography methods.

One approach currently being pursued for signature methods in post-quantum cryptography is that of hash-based cryptography, which enables digital signatures to be created. Hash-based cryptographic signature methods have been developed since the 1970s and are based in particular on Lamport signatures and Merkle signature methods and are currently being extended by more modern algorithms such as the XMSS method (XMSS=“Extended Merkle Signature Scheme”) or the LMS method (LMS=“Leighton-Micali Signatures”). The XMSS method here uses a signature method in the form of a modified Winternitz signature method, a one-time signature method, and combines this signature method with hash trees. In the XMSS method, the hash trees consist of so-called L trees and a Merkle tree, whereby a plurality of one-time signatures can be verified with one public key since all the public keys are contained in the Merkle tree; the root of the Merkle tree then represents the combined public key. In the context of the present application, in the German text the designation Root [“root”] should be understood to mean the Wurzel [“root”] of a hash tree, and so the terms Root and Wurzel are used synonymously.

Hash-based methods such as the XMSS method and the LMS method are based on an efficient combination of a defined number of one-time signature keys. Consequently, the methods mentioned above can also create at most a number of signatures such as corresponds to the previously defined number. This maximum number of signatures is defined before key generation. If the maximum number of signatures is chosen to be quite large, then the duration of key generation scales linearly with the number of signatures. The length of the signatures increases with the logarithm of the number of signatures.

In order to accelerate key generation for keys with a large number of signatures, multi-tree variants of XMSS and LMS have been developed. These multi-tree methods do not use a single Merkle tree, but rather a tree of Merkle trees, i.e. a tree whose nodes and leaves each contain an XMSS tree; such a tree is also referred to as subtree hereinafter. Since key generation here can take place as part of signature generation and in particular after root generation, this method can generate even large numbers of keys.

In a manner similar to that in the case of the simple XMSS method or LMS method, however, it is necessary to define the maximum number of signatures for key generation in the case of the multi-tree methods as well.

In many applications, however, it is not yet known at all how many signatures are actually required. Therefore, in practice, often an unnecessarily large number of signatures are provided, such that the signatures are chosen to be unnecessarily long and an unnecessarily high computational complexity is thus chosen.

### SUMMARY

Teachings of the present disclosure include improved computer-implemented methods for providing cryptographic keys for signing data in which the computational complexity can easily be kept low, signature modules, methods for signing data, and/or methods for authenticated communication which can be carried out with the methods for providing cryptographic keys for signing data described herein.

### BRIEF DESCRIPTION OF THE DRAWINGS

The teachings of the present disclosure are explained in greater detail below on the basis of an exemplary embodiment indicated in the drawing, in which:

FIG. 1 shows schematically in a basic diagram a hash tree structure known from the prior art with a plurality of XMSS trees;

FIG. 2 shows schematically in a basic diagram a hash tree structure in a memory of a signature module at a first point in time when carrying out a method incorporating teachings of the present disclosure for providing cryptographic keys;

FIG. 3 shows schematically in a basic diagram the hash tree structure in accordance with FIG. 2 at a second point in time, succeeding the first point in time; and

FIG. 4 shows schematically in a basic diagram the hash tree structure in accordance with FIGS. 2 and 3 at a third point in time, succeeding the second point in time.

### DETAILED DESCRIPTION

The method described herein for providing cryptographic keys for signing data is computer-implemented. In an example method, a plurality of keys are kept available as leaves of a hash tree structure having at least one first hash tree, the number of hash trees of the hash tree structure not being predetermined. A requirement criterion for a requirement for additional keys is used and evaluated and, if it is established that the requirement criterion is satisfied, a number of additional keys are generated. The additionally generated keys are kept available as leaves of at least one further hash tree, the at least one further hash tree being integrated into the hash tree structure in such a way that the root of each at least one further hash tree is signed with a key of a leaf of the hash tree structure. In this case, a key of a leaf means a key which forms this leaf.

It is therefore not necessary to use hash trees that are predefined in terms of their number, height and structure, rather hash tree structures can grow in a requirement-dependent manner when a requirement for new keys is foreseeable. Therefore, a new hash tree in the sense of a subtree as described above is formed only when the provision of new keys appears to be necessary. Consequently, the number of necessary keys is not predetermined, i.e. determined in advance, by a hash tree structure defined in advance with a predetermined number of hash trees. The number of providable cryptographic keys is unlimited in principle, and so the methods described herein can also be used in applications with high availability requirements and, associated therewith, with a high and continuous requirement for new cryptographic keys. The hash tree structure need not be designed in advance for a specific number of keys.

Consequently, a number of signatures is not defined in advance, rather the hash tree structure grows depending on a currently evaluated requirement criterion. Consequently, since the number of signatures and the depth of the hash tree structure need not be chosen to be unnecessarily high in advance, the signatures need not be chosen to be unnecessarily long and the computational complexity for generating and for using the signatures increases at most to the extent that this increased computational complexity is actually necessary owing to a requirement for keys to be newly provided.

In some embodiments, the various steps or elements of the method may be repeated.

In some embodiments, the hash tree structure is a multi-tree structure and, the first hash tree and the further hash tree are XMSS hash trees. In this, it is possible to use established hash tree structures of known cryptographic signature methods. In this way, already existing cryptographic systems can easily be updated and adapted and extended for the use of the solutions described herein.

The keys are suitably one-time keys or so-called “few-time signatures”, also referred to as “few-time keys”. It is the case precisely for one-time keys or few-time keys that, e.g. by means of hash-based cryptographic methods known per se, according to present knowledge, these keys can be designed and used securely vis-à-vis quantum computer-assisted attacks.

In some embodiments, the keys are hash-based keys. According to present knowledge, finding preimages of a hash function is sufficiently difficult even for quantum computers, and so the methods described herein remain securely implementable even given future availability of powerful quantum computers.

In some embodiments, the keys are each public keys of a respective asymmetric key pair. In some embodiments, the keys are each private keys of a respective asymmetric key pair.

The keys may be each Winternitz signature keys, i.e. keys designed for signature according to the Winternitz signature method. In some embodiments, the keys are each Lamport signature keys, i.e. keys designed for signature according to the Lamport signature method. In some embodiments, the keys are each HORST signature keys, i.e. keys designed for signature according to the HORST signature method, a few-time signature method. The three signature methods mentioned above, in particular, are known as quantum computer-resistant, and so in this development the methods described herein are designed to be particularly future-proof.

In some embodiments, the requirement criterion depends on a number of keys of the hash tree structure that are already used for signature. In this, the requirement for additional keys can be predicted on the basis of use progress during the use of the keys provided, and the hash structure can be extended foresightedly by a requirement to be expected in the future.

In some embodiments, the requirement criterion depends on a number of keys still provided for use, and/or on an age of the hash tree structure or of the first hash tree.

The signature modules described herein are designed for carrying out a computer-implemented method for providing cryptographic keys as described above, and the signature module comprises for this purpose a memory, storing a hash tree structure having a first hash tree with a plurality of keys as leaves of the hash tree structure, and with a number of hash trees not defined previously, and comprises an evaluation unit for evaluating that a requirement criterion is satisfied, and also a key generating module, which is configured for generating additional keys as leaves of at least one further hash tree depending on the requirement criterion being satisfied and which is configured for integrating the at least one further hash tree into the hash tree structure by means of a signature of a respective root of the at least one further hash tree with a key of a leaf of the hash tree structure.

In some embodiments, in the case of a requirement for additional cryptographic keys, at least one additional cryptographic key is provided and at least one file is signed by means of the at least one additional cryptographic key, e.g. by means of a signature module as described herein.

In some embodiments, the communication is effected by means of at least one signed file, the at least one signed file being encrypted by means of a method for signing data as described above.

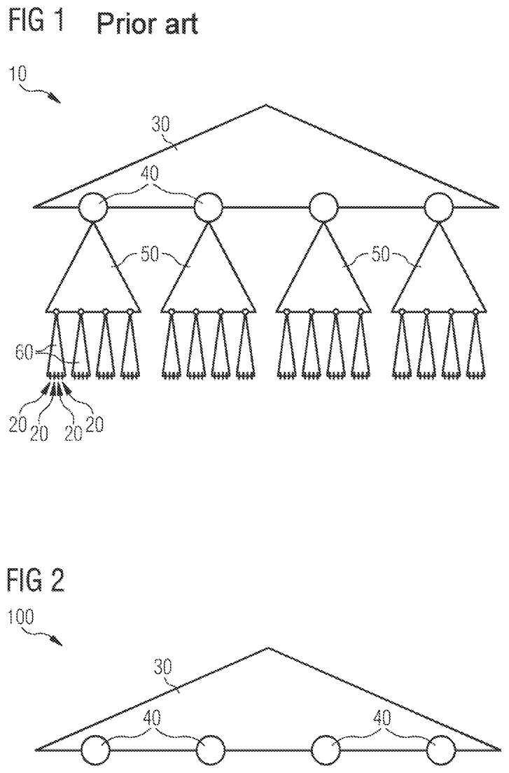

The hash tree structure 10 illustrated in FIG. 1 serves for digitally signing data in a manner known from the prior art. For this purpose, the hash tree structure 10 provides digital signature keys 20 (designated uniformly by the reference sign 20 in the drawing; the signature keys 20 are mutually different and not identical).

For providing the signature keys 20, the hash tree structure 10 comprises a first XMSS tree 30, which is formed with a Merkle tree and L trees. In a manner known, the XMSS tree 30 comprises leaves in the form of one-time keys 40, by means of which user data can be signed digitally. In the case of the hash tree structure 10 in accordance with FIG. 1, said one-time keys 40 do not serve for directly signing user data, rather roots of further XMSS trees 50, constructed in an identical fashion, are signed by means of the one-time keys 40. With leaves of these XMSS trees 50, in turn further XMSS trees 60 are signed, the leaves of which then form the signature keys 20. By means of these signature keys 20, keys of the hash tree structure 10 are available by means of which user data, for example electronic documents (not explicitly shown in FIG. 1), can be digitally signed.

The public key is formed by the root of the first XMSS tree 30, illustrated here as a vertex of the triangle symbolizing the first XMSS tree 30. The digital signatures generated by means of a signature key 20 contain the complete signature chain of the XMSS trees 60, of the XMSS trees 50 of the overlying level of the hash tree structure 10, and of the first XMSS tree 30.

In accordance with the hash tree structure 10 illustrated in FIG. 1, the depth of the hash tree structure 10 and also the choice of the XMSS trees 50, 60 linked to the first XMSS tree 30 are already defined during key generation. In this case, a depth of the hash tree structure 10 should be understood to mean the number of roots—interlinked by means of one-time signatures 40—of XMSS trees 50, 60, 30 by means of which the signature keys 20 are linked with the root of the first XMSS tree 30. In this case, the depth of the hash tree structure 10 overall means the maximum number of linked roots which can occur in the case of a signature key 20. By contrast, the local depth of the hash tree structure 10 in the case of a concrete signature with the aid of the signature keys 20 means the interlinked roots proceeding from the concrete signature key 20 as far as the root of the first XMSS tree 30.

Consequently, the depth of the hash tree structure 10 and the number of possible signature keys 20 are already fixed at the time of key generation of the public key, here the root of the first XMSS tree 30: in the exemplary embodiment illustrated in FIG. 1, four signatures can be carried out with each individual XMSS tree 60, 30, or 60. This number has been chosen for illustrative purposes in the exemplary embodiment illustrated. In further embodiments, which for the rest correspond to the exemplary embodiment illustrated, 2⁵, i.e. 32, signatures, 2¹⁰ signatures or 2²⁰ signatures are provided per XMSS tree 60.

The number of signature keys 200 and in particular the number of XMSS trees of the hash tree structure 100 are not fixed from the outset, in contrast to the prior art.

A hash tree structure 100 is formed by beginning with a first XMSS tree 30 as illustrated in FIG. 2. In this case, however, the depth of the hash tree structure 100 is defined dynamically:

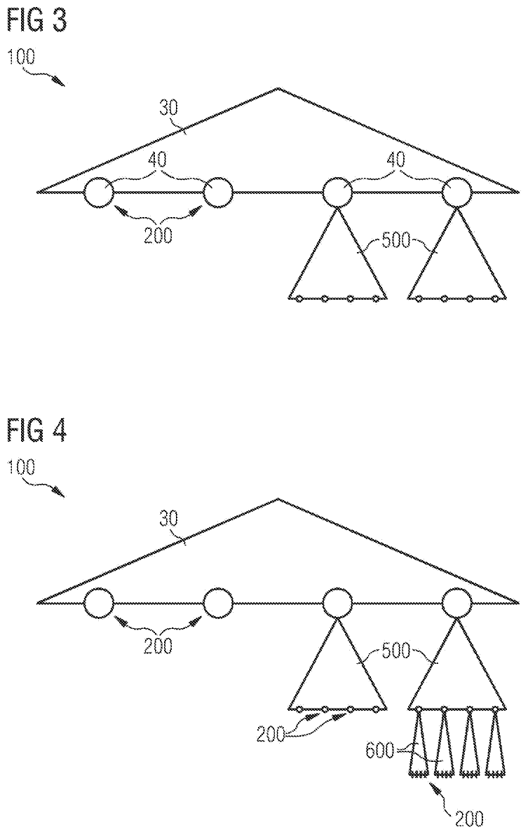

For this purpose, a requirement value is defined, the depth of the hash tree structure 100 increasing when said requirement value is reached. In the exemplary embodiment illustrated in FIGS. 2, 3, and 4, the requirement value is defined as consumption of 50 percent of the one-time keys 40 available hitherto. Firstly, the leaves 40 of the first XMSS tree 30 are thus used as signature keys 200 in the method according to the invention. If a proportion amounting to 50 percent of the available leaves of the first XMSS tree 30 has already been used, then the remaining one-time keys 40 are not themselves used as signature keys 200, rather the remaining one-time keys 40 of the first XMSS tree 30 are used for signing roots of further XMSS trees 500. These further XMSS trees 500 are created when the requirement value is reached, and are integrated into the previous hash tree structure 100 by means of signing with the one-time keys 40. In the illustration in FIG. 3, 8 further one-time keys 40 are now available, which can be used in principle as signature keys 200.

If half of the remaining 8 signature keys are then in turn used, i.e. as it were consumed, the roots of once again newly generated XMSS trees 600 are signed with the remaining one-time keys of the XMSS trees 500 of the tree.

These method elements can be repeated as often as desired, and so in principle as many signatures as desired can be generated with the aid of the signature keys 200. Therefore, the signature of a message or document using a signature key 200 is thus always performed by means of a one-time key of an XMSS tree 30, 500, 600 at the locally lowest level of the hash tree structure 100, i.e. by means of a one-time key 40 by means of which no root of a further XMSS tree has been signed.

When the methods described herein are carried out, the depth of the hash tree structure 100 increases. As a result, the signature keys 200 generated become longer and longer. However, the length of the signature keys 200 generated according to the invention still remains comparable with signature keys 20 generated according to the method according to the prior art. In principle, in further embodiments, a suitable compromise that results in a suitable requirement value can be chosen: in this regard, the fraction of signature keys 200 which have to be consumed before a new XMSS tree 600 is integrated into the hash tree structure 100 can be chosen suitably.

In some embodiments, the integration of new XMSS trees 500, 600 need not be effected when a specific, fixed proportion of consumed signature keys 200 is reached. Rather, it is also possible to choose a requirement value that depends on the current depth of the hash tree structure 100, where the requirement value can optionally also additionally comprise further circumstances, for instance an age of the hash tree structure 100 or a number of signature keys 200 used hitherto per unit time.

In some embodiments, the XMSS trees 500, 600 integrated into the hash tree structure 100 need not necessarily have the same size, rather it is possible for example firstly to integrate XMSS trees with 2⁵ one-time keys 40 and then, if a requirement frequency per unit time increases, to integrate XMSS trees with 2²⁰ one-time keys 40, which are then potentially available as signature keys 200.

In some embodiments, the requirement value can additionally define at what point an XMSS tree 500, 600 of what size is intended to be added in order to satisfy the requirement for new signature keys 200. For if new XMSS trees 500, 600 are inserted at an already existing level of the hash tree structure 100, i.e. if newly integrated XMSS trees 500, 600 do not increase the depth of the hash tree structure 100, then the signature length remains the same. The signature keys only become longer with the local depth of the hash tree structure 100, i.e. with the depth of the hash tree structure 100 in the case of the signature key 200.

Since the hash tree structure 100 grows dynamically and not in a manner defined specifically from the outset, the method involves additionally storing the point at which an XMSS tree is integrated into the hash tree structure 100. This information is stored with integrity protection internally or externally. In exemplary embodiments that are not illustrated separately, this information is calculated from the number of signature keys 200 used hitherto.

In some embodiments, the complete signature chain is not provided, rather what is provided is only a part of the signature from that XMSS tree 500, 600, 30 which contains the signature key 200, since the other signatures have already been checked and are stored with integrity protection. In this case, therefore, the length of the signature keys 200 need not concomitantly increase with the depth of the hash tree structure 100 in the case of the signature key 200. This variant can be used advantageously whenever a party that signs by means of the signature key 200 knows which signature keys 200 have already been obtained by all conceivable recipients of the signed file that would like to verify this file with the signature key 200. This may be the case particularly if all the signature keys 200 can be published and queried at any time, e.g. in a blockchain context.

The methods described herein may be carried out by means of a signature module incorporating teachings of the present disclosure. The signature module is configured to keep the requirement value available and to integrate new XMSS trees 500, 600 into the hash tree structure 100 in line with the requirement value.

For this purpose, an example signature module comprises a memory, storing the hash tree structure 100, and additionally comprises an evaluation unit for evaluating the requirement value and also a key generating module, which is configured for generating additional keys as leaves of at least one further XMSS tree 500, 600 and which is configured for integrating the at least one further XMSS tree 500, 600 into the hash tree structure 100 by means of signing with a one-time key of the root of the at least one further XMSS tree 500, 600.

The signature keys 200, like signatures provided previously according to the methods for signing data, are used to digitally sign data, in particular documents. By means of the various methods for signing data, communication data are signed and the signed communication data are exchanged. A method for authenticated communication is carried out in this way.

What is claimed is:

1. A method for providing cryptographic keys for signing data, the method comprising:
providing a plurality of keys as leaves of a hash tree structure having at least one first hash tree;
wherein a number of hash trees of the hash tree structure is not predetermined;
evaluating a requirement criterion for a requirement for additional keys and, if the requirement criterion is satisfied, generating a plurality of additional keys available as leaves of a further hash tree;
integrating the further hash tree into the hash tree structure so a respective root of the further hash tree is signed with a leaf of the hash tree structure.

2. The method as claimed in claim 1, further comprising repeating the evaluation and integration.

3. The method as claimed in claim 1, wherein:
the hash tree structure comprises a multi-tree structure; and
the first hash tree and the further hash tree comprise XMSS hash trees.

4. The method as claimed in claim 1, wherein the keys are one-time keys.

5. The method as claimed in claim 1, wherein the keys each comprise hash-based keys.

6. The method as claimed in claim 1, wherein the keys each comprise a respective public key of a respective asymmetric key pair.

7. The method as claimed in claim 1, wherein the keys each comprise: Winternitz signature keys, WOTS keys, and/or WOTS+ keys designed for signature according to a corresponding signature method.

8. The method as claimed in claim 1, wherein the keys are each Lamport signature keys designed for signature according to the Lamport signature method.

9. The method as claimed in claim 1, wherein the requirement criterion depends on a number of keys of the hash tree structure that are already used for signature.

10. The method as claimed in claim 1, wherein the requirement criterion depends on a number of keys still available for use.

11. The method as claimed in claim 1, wherein the requirement criterion depends on an age of the hash tree structure or of the first hash tree.

12. A signature module for providing cryptographic keys, comprising:
a memory storing a hash tree structure with a first hash tree having a plurality of keys as leaves of the hash tree structure, wherein a count of the hash trees of the hash tree structure is not predetermined;
an evaluation unit to evaluate whether a requirement criterion is satisfied; and
a key generating module to generate additional keys as leaves of a further hash tree depending if the requirement criterion is satisfied and to integrate the further hash tree into the hash tree structure using a signature of a respective root of the further hash tree with a leaf of the hash tree structure.

13-14. (canceled)
